(19) United States
(12) Patent Application Publication
(10) Pub. No.: US 2018/0146806 A1
(43) Pub. Date: May 31, 2018

(54) DOUBLE-SIDED GYM FLOORING TOWEL

(71) Applicant: GROUNDING INC., TORTOLA (VG)

(72) Inventor: Victor TSAI, TAIPEI CITY (TW)

(21) Appl. No.: 15/652,936

(22) Filed: Jul. 18, 2017

(30) Foreign Application Priority Data
Nov. 28, 2016 (TW) 105139081

(51) Int. Cl. A47G 9/06; A47K 10/02; B32B 5/02; B32B 3/30

(52) U.S. Cl. CPC A47G 9/062; B32B 3/30; B32B 5/02; A47K 10/02

(57) ABSTRACT

A double-sided gym flooring towel includes a fabric layer defining a central zone and two opposing lateral zones on each of opposing top and bottom surfaces thereof, a first anti-slip layer bonded to the top surface of the fabric layer and covering the respective two lateral zones and providing a plurality of separated first openings to expose a part of the top surface of the fabric layer, and a second anti-slip layer bonded to the bottom surface of the fabric layer and covering the respective two lateral zones and providing a plurality of separated second openings to expose a part of the bottom surface of the fabric layer.

### BACKGROUND OF THE INVENTION

### 1. Field of the Invention

The present invention relates to sports towels, and more particularly, to a double-sided gym flooring towel.

### 2. Description of the Related Art

Taiwan Patent 1513436 discloses double-sided anti-slip gym flooring towel for floor exercises. This design of double-sided anti-slip gym flooring towel comprises a fabric layer, and two perforated anti-slip layers respectively bonded to the opposing top and bottom surfaces of the fabric layer for enabling the top and bottom surfaces to be partially exposed to the outside. The fabric layer is adapted to provide the skin of the user with an anti-slip effect when the user is sweating; the perforated anti-slip layers are adapted to provide the skin of the user with an anti-slip effect when the skin of the user is dry, and thus, the double-sided anti-slip gym flooring towel can provide an anti-slip effect either when dry or wet.

However, the aforesaid prior art design does not disclose the technical features of the arrangement of each anti-slip layer in a continuous form and the location of each anti-slip layer on the top or bottom surface of the fabric layer. The arrangement of each anti-slip layer in a continuous piece enhances its security on the fabric layer. Further, the location of each anti-slip layer on the fabric layer must be within the area where the user will frequently touch. Therefore, the aforesaid prior art design still has room for improvement.

### SUMMARY OF THE INVENTION

The present invention has been accomplished under the circumstances in view. It is the main object of the present invention to provide a double-sided gym flooring towel, which has an anti-slip layer covered over each selected zone of a fabric layer in the form of a continuous piece without disconnection, which can help to be secured onto the fabric layer.

It is another object of the present invention to provide a double-sided gym flooring towel, which has an anti-slip layer bonded securely onto two frequently used lateral zones of a fabric layer thereof, providing an optimal anti-slip effect.

To achieve these and other objects of the present invention a double-sided gym flooring towel comprises a fabric layer, a first anti-slip layer and a second anti-slip layer. The fabric layer is a foldable piece of soft cloth with water absorption capacity, having a rectangular shape with two opposing long sides and two opposing short sides. Further, the fabric layer defines on each of opposing top and bottom surfaces thereof a central zone and two opposing lateral zones. The two lateral zones are respectively located at two opposite lateral sides of the central zone, and respectively disposed adjacent to the two opposing short sides. The first anti-slip layer is bonded to the top surface of the fabric layer within the respective two opposing lateral zones. Further, the first anti-slip layer comprises a plurality of first openings that expose the top surface of the fabric layer. These first openings are respectively surrounded by the first anti-slip layer, and kept apart from one another. The second anti-slip layer is bonded to the bottom surface of the fabric layer within the respective two opposing lateral zones. Further, the second anti-slip layer comprises a plurality of second openings that expose the bottom surface of the fabric layer. These second openings are respectively surrounded by the second anti-slip layer, and kept apart from one another. Further, in the first anti-slip layer within every area corresponding to the palm of the human hand excluding the finger area, a part of the top surface of the fabric layer and a part of the first anti-slip layer are exposed to the outside. In the second anti-slip layer within every area corresponding to the palm of the human hand excluding the finger area, a part of the bottom surface of the fabric layer and a part of the second anti-slip layer are exposed to the outside.

Thus, since the first anti-slip layer and the second anti-slip layer are respectively a continuous piece without disconnection, the arrangement of the first anti-slip layer and the second anti-slip layer greatly enhances the secure effect of the fabric layer. Further, since the first anti-slip layer and the second anti-slip layer are respectively arranged on the respective lateral zones of the opposing top and bottom surfaces of the fabric layer, the double-sided gym flooring towel provides excellent anti-slip effects.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a top view of a double-sided gym flooring towel in accordance with a first embodiment of the present invention.

FIG. 2 is an enlarged view of a part of FIG. 1.

FIG. 3 is a sectional view taken along line 3-3 of FIG. 2.

FIG. 4A illustrates one design example of the first openings of the first anti-slip layer of the double-sided gym flooring towel in accordance with the first embodiment of the present invention.

FIG. 4B illustrates another design example of the first openings of the first anti-slip layer of the double-sided gym flooring towel in accordance with the first embodiment of the present invention.

FIG. 4C illustrates still another design example of the first openings of the first anti-slip layer of the double-sided gym flooring towel in accordance with the first embodiment of the present invention.

FIG. 4D illustrates still another design example of the first openings of the first anti-slip layer of the double-sided gym flooring towel in accordance with the first embodiment of the present invention.

FIG. 5 is a schematic drawing illustrating a status of use of the double-sided gym flooring towel in accordance with the first embodiment of the present invention.

FIG. 6 is a top view of an alternate form of the double-sided gym flooring towel in accordance with the first embodiment of the present invention.

FIG. 7 is a top view of a double-sided gym flooring towel in accordance with a second embodiment of the present invention.

FIG. 8 is a top view of a double-sided gym flooring towel in accordance with a third embodiment of the present invention.

### DETAILED DESCRIPTION OF THE INVENTION

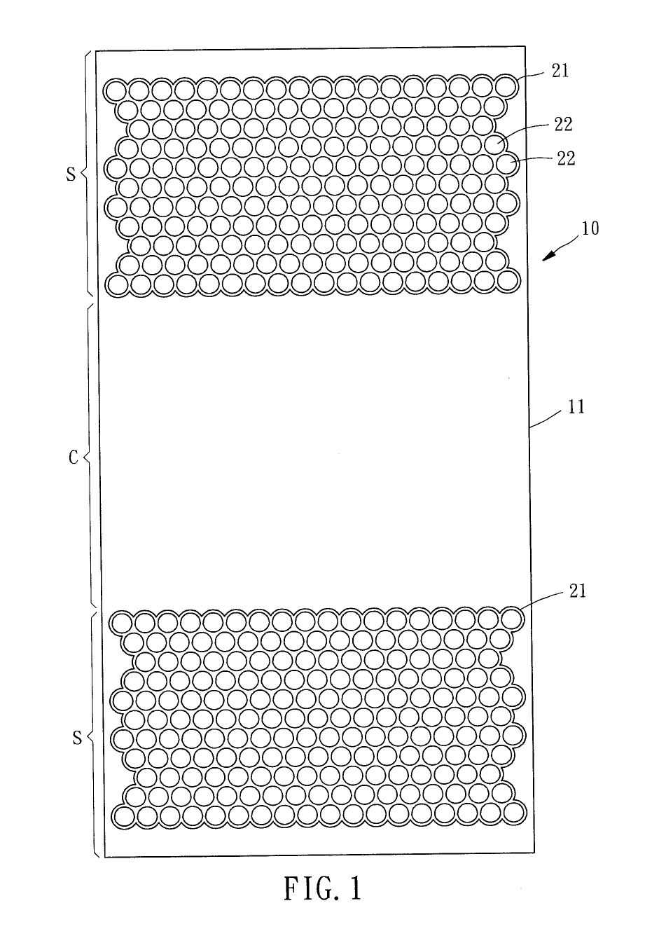

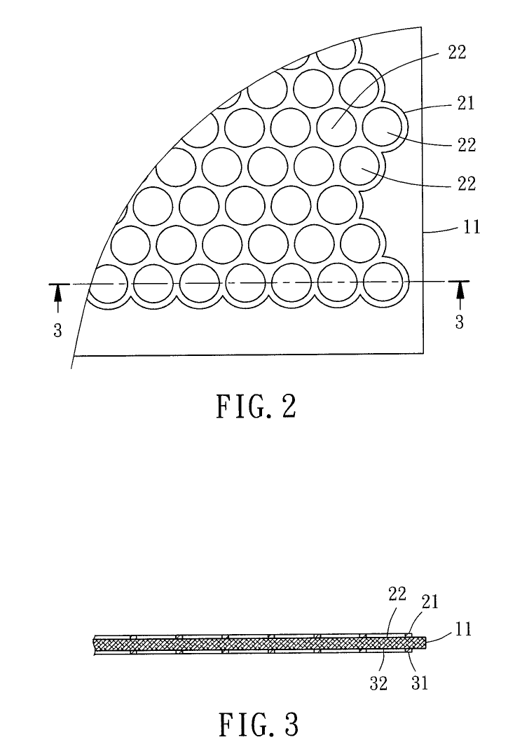

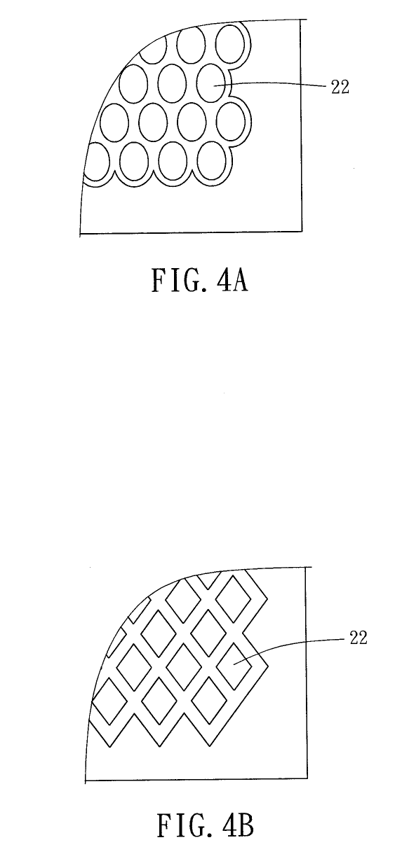

Referring to FIGS. 1-3, a double-sided gym flooring towel 10 in accordance with a first embodiment of the present invention is shown. The double-sided gym flooring towel 10 comprises a fabric layer 11, a first anti-slip layer 21 and a second anti-slip layer 31.

The fabric layer 11 is a foldable piece of soft cloth with water absorption capacity, having a rectangular shape with two opposing long sides and two opposing short sides. The fabric layer 11 defines on each of opposing top and bottom surfaces thereof a central zone C and two opposing lateral zones S. The two lateral zones S are respectively located at two opposite lateral sides of the central zone C and respectively disposed adjacent to the two opposing short sides.

The first anti-slip layer 21 is bonded to the top surface of the fabric layer 11 and covered over the whole area of the respective lateral zones S, comprising a plurality of first openings 22 that expose the top surface of the fabric layer 11. The first openings 22 are respectively surrounded by the first anti-slip layer 21 and kept apart from one another. The part of the first anti-slip layer 21 on each lateral zone S outside the respective first openings 22 is a continuous piece without disconnection. The first anti-slip layer 21 is a flexible layer that can be curved with the fabric layer 11 when folding.

The second anti-slip layer 31 is bonded to the bottom surface of the fabric layer 11 and covered over the whole area of the respective lateral zones S, comprising a plurality of second openings 32 that expose the top surface of the fabric layer 11. The second opening 32 are respectively surrounded by the second anti-slip layer 31 and kept apart from one another. The part of the second anti-slip layer 31 on each lateral zone S outside the respective second openings 32 is a continuous piece without disconnection. The second anti-slip layer 31 is a flexible layer that can be curved with the fabric layer 11 when folding.

Further, in the first anti-slip layer 21 within any area corresponding to the palm of the human hand excluding the finger area, there must be a part of the top surface of the fabric layer 11 and a part of the first anti-slip layer 21 exposed to the outside; in the second anti-slip layer 31 within any area corresponding to the palm of the human hand excluding the finger area, there must be a part of the bottom surface of the fabric layer 11 and a part of the second anti-slip layer 31 exposed to the outside.

In actual application, the first anti-slip layer 21 and the second anti-slip layer 31 can be spaced from the border edge of the fabric layer 11 by a predetermined distance, facilitating fabrication. However, the first anti-slip layer 21 and the second anti-slip layer 31 can also be configured to respectively extend to the border edge of the fabric layer 11. This alternate arrangement can be directly understood, and therefore, it is no need to express by drawings. However, during fabrication of this alternate arrangement, the connection relationship between the first and second anti-slip layer 21,31 and the fabric layer must be seriously considered. The fabrication of this alternate arrangement is complicated.

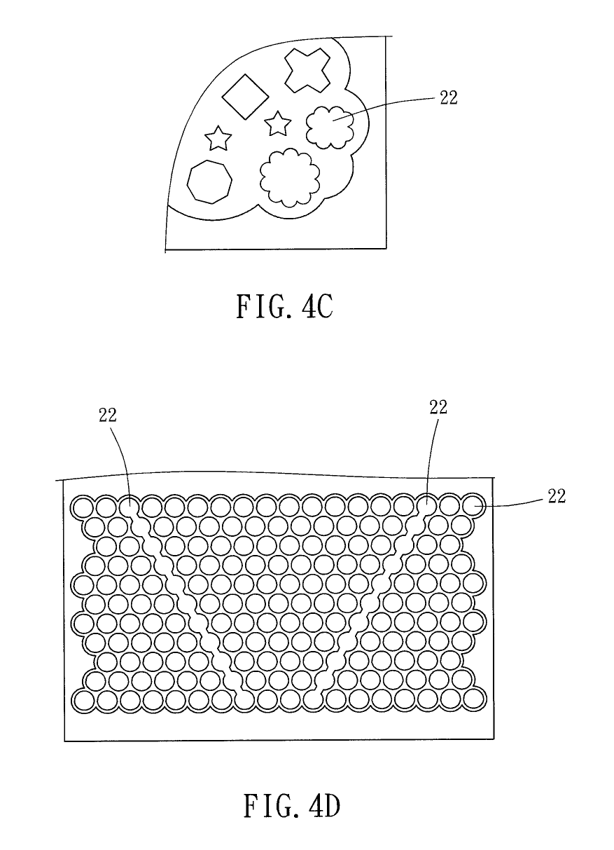

Referring to FIGS. 4A-4D, the first openings 22 and the second openings 32 (not shown) can be configured to exhibits a circular shape, oval shape, polygonal shape, or any other irregular shape. In this embodiment, the first openings 22 and the second openings 32 have a circular shape. Further, the first openings 22 are spaced from one another and arranged in an array; the second openings 32 (not shown) are also spaced from one another and arranged in an array.

After understood the structural details of the first embodiment of the present invention, the application of the double-sided gym flooring towel 10 is explained hereinafter.

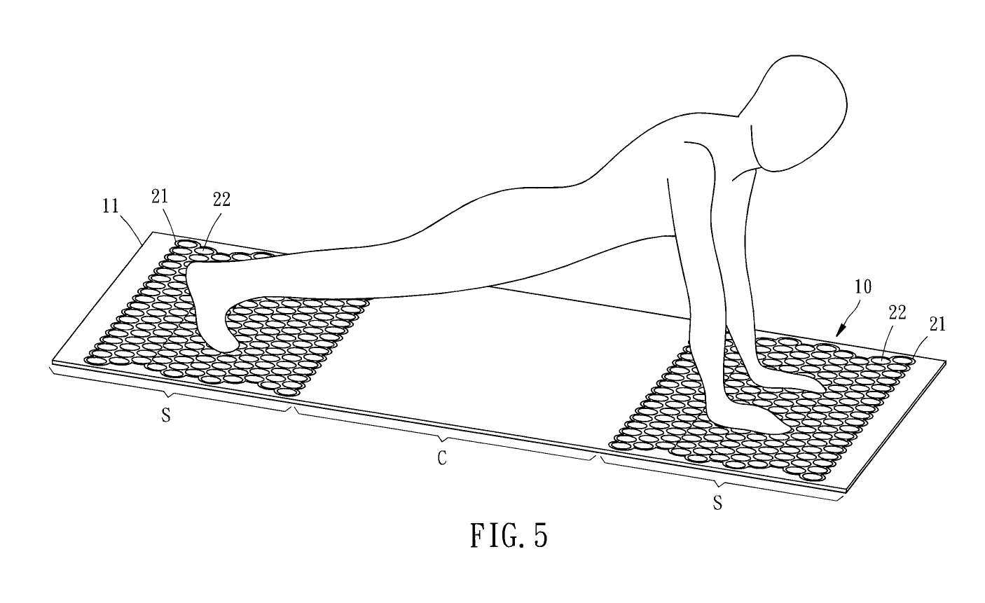

Referring to FIGS. 1-5, when using the double-sided gym flooring towel 10, put the double-sided gym flooring towel 10 on the floor or a floor mat in a top-facing position. In the example shown in the drawing, the double-sided gym flooring towel 10 is placed on the floor. Thereafter, the user can perform floor exercises on the double-sided gym flooring towel 10. In exercises, the part of the fabric layer 11 that is exposed to the first openings 22 and the part of the first anti-slip layer 21 that is touched by the user provide sweat absorption and anti-skid effects; the second anti-slip layer 31 that is located on the bottom surface of the fabric layer 11 and supported on the floor provides an anti-slip effect. Since the first anti-slip layer 21 and the second anti-slip layer 31 are covered over the whole areas of the lateral zones S of the opposing top and bottom surfaces of the fabric layer 11 and the lateral zones S are the areas that are most frequently used in Yoga exercises, the invention provides the most frequently used areas with effective anti-slip effects. Further, because the first anti-slip layer 21 and the second anti-slip layer 31 are respectively covered on the lateral zones S of the opposing top and bottom surfaces of the fabric layer 11, the user in the use of the double-sided gym flooring towel 10 clearly knows that there must be an anti-slip structure below, so the uses can get more peace of mind in exercises. Further, in the first or second anti-slip layer 21,31 within any area corresponding to the palm of a human hand excluding the finger area, there must be a part of the fabric layer 11 and a part of the first or second anti-slip layer 21,31 exposed to the outside, thus the user definitely will touch the fabric layer 11 and the first or second anti-slip layer 21,31 at the same time when performing exercises, ensuring an optimal anti-slip effect.

Since the first anti-slip layer 21 or second anti-slip layer 31 within each lateral zone S is a continuous piece without disconnection, the arrangement of the first anti-slip layer 21 and the second anti-slip layer 31 greatly enhances the secure effect of the fabric layer 11. Further, since the central zones C of the top and bottom surfaces of the fabric layer 11 are not covered by the first anti-slip layer 21 or second anti-slip layer 31, if the user sweats during the exercise, the user can use the central zone C of the top or bottom surface of the fabric layer 11 to wipe sweat away, and then continue the follow-up motion.

It is to be noted that the central zone C of the top surface of the fabric layer 11 and the central zone C of the bottom surface of the fabric layer 11 can be different in size, i.e., as long as the two lateral zones S cover the area commonly used by the user, the size of the two lateral zones S of the top surface of the fabric layer 11 and the size of the two lateral zones S of the bottom surface of the fabric layer 11 can be different according to the designer's settings at the factory.

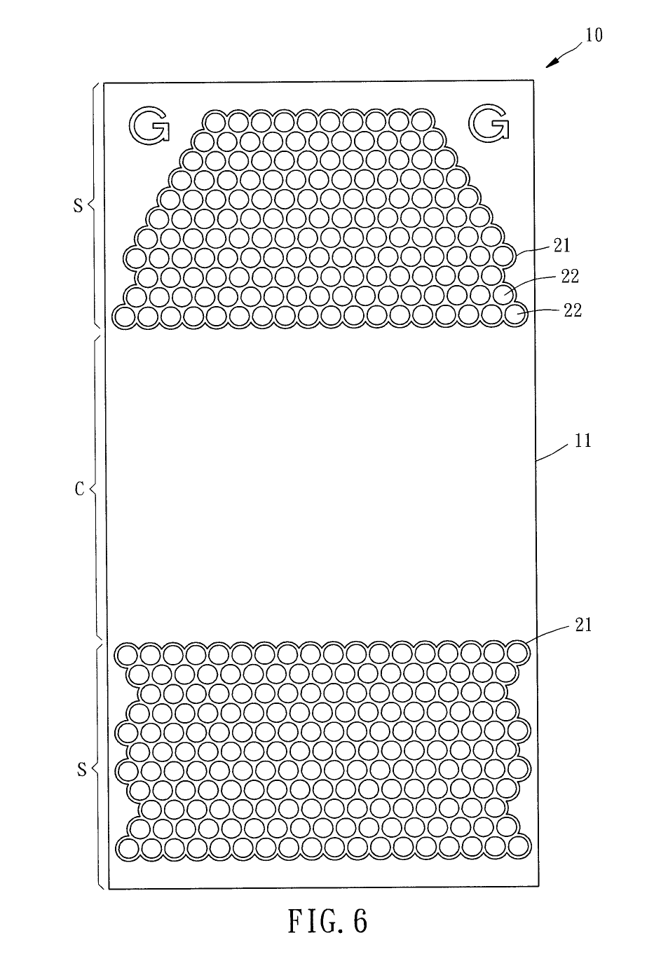

Further, as illustrated in FIG. 6, the first anti-slip layer 21 can be configured to cover only a part of the two lateral zones S of the top surface of the fabric layer 11; the second anti-slip layer 31 can also be configured to cover only a part of the two lateral zones S of the bottom surface of the fabric layer 11. In this case, the empty areas can be used for other purposes, for example, for printing a trademark or text via ink or anti-slip material same to the first anti-slip layer 21 to exhibit a wide variation in design.

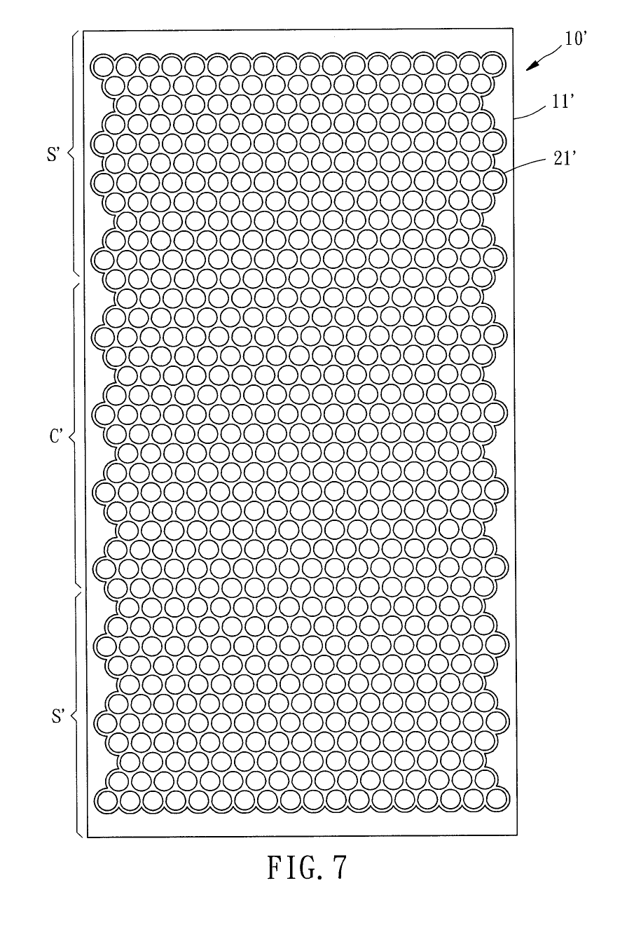

Referring to FIG. 7, a double-sided gym flooring towel 10′ in accordance with a second embodiment of the present invention is shown. This second embodiment is substantially similar to the aforesaid first embodiment with the exceptions as follows:

The first anti-slip layer 21′ is covered over the two lateral zones S′ of the top surface of the fabric layer 11′ and the central zone C′ of the top surface of the fabric layer 11′, and made in the form of a continuous piece without disconnection.

The second anti-slip layer (that is symmetric to the first anti-slip layer, and thus, not expressed by drawings) is covered over the two lateral zones S′ of the bottom surface of the fabric layer 11′ and the central zone C′ of the bottom surface of the fabric layer 11′, and made in the form of a continuous piece without disconnection.

The first anti-slip layer 21′ and the second anti-slip layer 31′ can be configured to cover the central zones C′ of the top and bottom surfaces of the fabric layer 11′ respectively. Alternatively, the double-sided gym flooring towel 10″ can be so configured that simply the first anti-slip layer 21′ or second anti-slip layer 31′ covers the central zone C′ of the top or bottom surface of the fabric layer 11′ to satisfy different requirements.

Having the first anti-slip layer 21′ or second anti-slip layer 31′ on the central zone C′ of the top or bottom surface of the fabric layer 11′ provides a better anti-slip effect, however, under this arrangement, the respective central zone C′ can no longer be used for wiping sweat away.

Other structural details of this second embodiment and the effect this second embodiment can achieve are same as the aforesaid first embodiment, and thus, we will not repeat them.

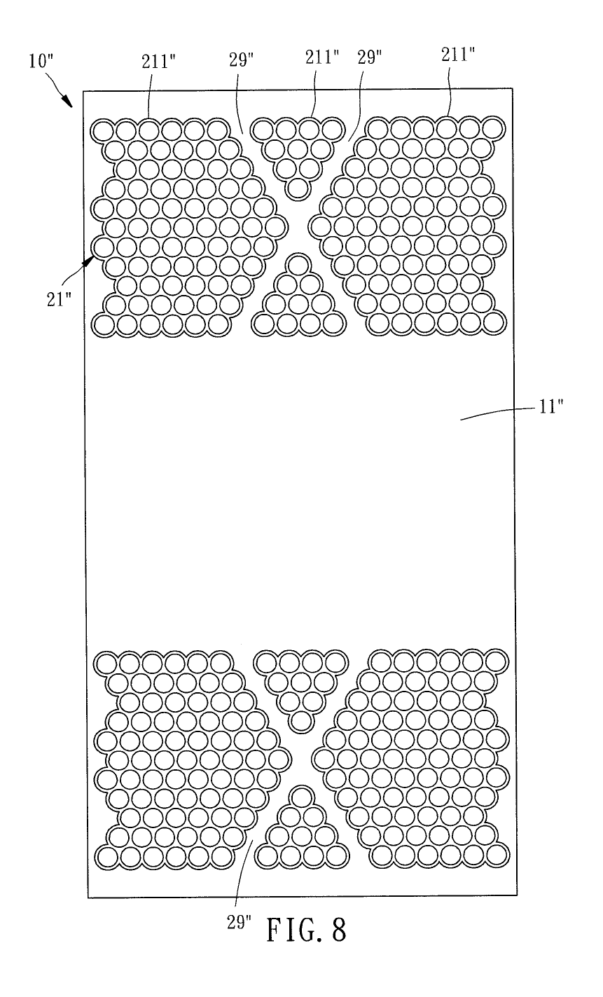

Referring to FIG. 8, a double-sided gym flooring towel 10″ in accordance with a third embodiment of the present invention is shown. This third embodiment is substantially similar to the aforesaid first embodiment with the exceptions as follows:

The first anti-slip layer 21″ is divided into multiple first sub anti-slip portions 211″ by at least one first delimited path 29″. The width of each first delimited path 29″ is smaller than the maximum width of the palm of a human hand excluding the finger area. In this embodiment, multiple first delimited paths 29″ are provided to divide the first anti-slip layer 21″ into multiple first sub anti-slip portions 211″. The second anti-slip layer (that is located on the bottom surface of the fabric layer 11″ in the same manner as the first anti-slip layer 21″, and thus, it is not expressed by drawings) is divided into a plurality of second sub anti-slip portions by at least one delimited path where the width of each delimited path is smaller than the maximum width of the palm of a human hand excluding the finger area. In this embodiment, multiple delimited paths 29″ are provided to divide the first anti-slip layer 21″ and the second anti-slip layer into multiple first sub anti-slip portions 211″ and multiple second sub anti-slip portions respectively, and also to expose the top and bottom surfaces of the fabric layer 11″ respectively.

Further, the design of the delimited paths 29″ provide the first anti-slip layer 21″ and the second anti-slip layer with a visual effect, making them look less monotonous. Further, since the multiple delimited paths 29″ can expose the opposing top and bottom surfaces of the fabric layer 11″ respectively, they provide better sweat absorption effects. Further, since the width of each delimited path 29″ is smaller than the maximum width of the palm of a human hand excluding the finger area, the multiple delimited paths 29″ greatly enhance the anti-slip effect either when the first anti-slip layer 21″ or second anti-slip layer is dry or wet.

Other structural details of this third embodiment and the effect this third embodiment can achieve are same as the aforesaid first embodiment, and thus, we will not repeat them.

What is claimed is:

1. A double-sided gym flooring towel, comprising:
a fabric layer being a foldable piece of soft cloth with water absorption capacity, said fabric layer having a rectangular shape with two opposing long sides and two opposing short sides, said fabric layer defining on each of opposing top and bottom surfaces thereof a central zone and two opposing lateral zones, said two lateral zones being respectively located at two opposite lateral sides of said central zone and respectively disposed adjacent to the said two opposing short sides;
a first anti-slip layer bonded to said top surface of said fabric layer within the respective said two opposing lateral zones, said first anti-slip layer comprising a plurality of first openings that expose said top surface of said fabric layer, said first openings being respectively surrounded by said first anti-slip layer and kept apart from one another; and
a second anti-slip layer bonded to said bottom surface of said fabric layer within the respective said two opposing lateral zones, said second anti-slip layer comprising a plurality of second openings that expose said bottom surface of said fabric layer, said second openings being respectively surrounded by said second anti-slip layer and kept apart from one another;
wherein in said first anti-slip layer within every area corresponding to the palm of a human hand excluding the finger area, a part of said top surface of said fabric layer and a part of said first anti-slip layer are exposed to the outside; in said second anti-slip layer within every area corresponding to the palm of a human hand excluding the finger area, a part of said bottom surface of said fabric layer and a part of said second anti-slip layer are exposed to the outside.

2. The double-sided gym flooring towel as claimed in claim 1, wherein the part of said first anti-slip layer within each respective said lateral zone of said top surface of said fabric layer beyond the respective said openings is a continuous piece; the part of said second anti-slip layer within each respective said lateral zone of said bottom surface of said fabric layer beyond the respective said openings is a continuous piece.

3. The double-sided gym flooring towel as claimed in claim 1, wherein said first anti-slip layer is fully covered over the said two lateral zones of said top surface of said fabric layer; said second anti-slip layer is fully covered over the said two lateral zones of said bottom surface of said fabric layer.

4. The double-sided gym flooring towel as claimed in claim 3, wherein said first anti-slip layer covers the respective said lateral zones of said top surface of said fabric layer as well as the said central zone of said top surface of said fabric layer in the form of one continuous piece.

5. The double-sided gym flooring towel as claimed in claim 3, wherein said second anti-slip layer covers the respective said lateral zones of said bottom surface of said fabric layer as well as the said central zone of said bottom surface of said fabric layer in the form of one continuous piece.

6. The double-sided gym flooring towel as claimed in claim 3, wherein said first anti-slip layer covers the respective said lateral zones of said top surface of said fabric layer as well as the said central zone of said top surface of said fabric layer in the form of one continuous piece; said second anti-slip layer covers the respective said lateral zones of said bottom surface of said fabric layer as well as the said central zone of said bottom surface of said fabric layer in the form of one continuous piece.

7. The double-sided gym flooring towel as claimed in claim 1, wherein said first anti-slip layer is divided into a plurality of first sub anti-slip portions by at least one first delimited path thereof, each said first delimited path having a width smaller than the maximum width of the palm of a human hand excluding the finger area; said second anti-slip layer is divided into a plurality of second sub anti-slip portions by at least one second delimited path, each said second delimited path having a width smaller than the maximum width of the palm of a human hand excluding the finger area.

8. The double-sided gym flooring towel as claimed in claim 1, wherein said first anti-slip layer is spaced from the border edge of said fabric layer at a predetermined distance; said second anti-slip layer is spaced from the border edge of said fabric layer at a predetermined distance.

9. The double-sided gym flooring towel as claimed in claim 1, wherein said first openings and said second openings are selectively made in a circular, oval, polygonal or irregular shape.

10. The double-sided gym flooring towel as claimed in claim 1, wherein said first openings are spaced from one another and arranged in an array; said second openings are spaced from one another and arranged in an array.

11. The double-sided gym flooring towel as claimed in claim 1, wherein the said central zone of said top surface of said fabric layer and the said central zone of said bottom surface of said fabric layer are different in size.
